(19) United States
(12) Patent Application Publication
(10) Pub. No.: US 2010/0026652 A1
(43) Pub. Date: Feb. 4, 2010

(54) SYSTEM AND METHOD FOR USER INTERFACE

(76) Inventor: David Hirshberg, Haifa (IL)

Correspondence Address: David Hirshberg, 14a Hasachlav Street, Haifa, 34790, IL

(21) Appl. No.: 12/577,968

(22) Filed: Oct. 13, 2009

Related U.S. Application Data
(63) Continuation-in-part of application No. 11/216,021, filed on Sep. 1, 2005.

(51) Int. Cl. G06F 3/041; G06F 3/033

(52) U.S. Cl. 345/173; 345/184

(57) ABSTRACT

A user interface pointing apparatus for an electronic device. The apparatus comprises: a primary mechanical knob operated by a user using movement operations; one or more touch sensitive surfaces operated by a user using movement operations, the mechanical knob being adjacent to the touch sensitive surfaces; and a processor for receiving the movement operations and the touching operations for receiving said movement operations and said touching operations performed on the mechanical knob and the touch sensitive surfaces, wherein both the movement operations and the touching operations interpreted by the processor as pointing commands to the same pointer.

### RELATED APPLICATION/S

This application is a continuation-in-part of U.S. patent application Ser. No. 11/216,021 filed Sep. 1, 2005 which is incorporated herein by reference.

### FIELD OF THE INVENTION

The present invention relates to user interface for electronic devices and more particularly, to pointing user interface apparatuses.

### BACKGROUND OF THE INVENTION

Electronic devices are commonplace in our life nowadays. They are located everywhere, at homes and offices, as well as, like in the case of cellular phones, carried with us all day long. The need for a simple, intuitive and rich functionality input methods for user interface increases as time goes by. Due to the low price, reliability and flexibility, touch sensitive surfaces are becoming more and more popular and replacing traditional mechanical input devices.

Pointing is a fundamental input method in electronic devices. Many types of mechanical pointing devices are in use today. Mouse, joystick and trackball are the most popular ones. In the last decades touch sensitive surfaces and touch screens are used for pointing as well. Pointing devices are used not just for moving a pointer on a display, but also for moving, scaling and rotating objects on the display, scrolling lists or pane views on the display, as well as controlling variety of parameters of the system that the pointing device is attached thereto. The most common pointing device is two-dimensional (2-D) but in many cases one-dimensional (1-D) and three dimensional (3-D) and less frequently six-dimensional (6-D) pointing devices are in use as well. In some cases the pointing device is the central user interface device and the user operates the device almost continuously. There are broad requirements from a pointing device, from one side we would like to have very high resolution and accuracy, while on the other side we would like to move quickly over the full range. In some cases we would like to perform significant mechanical movement to gain better control and feedback on the operation, while in other cases where extended study operation is needed, one prefer to have more comfortable and less tiring operation. Both mechanical pointing devices and touch sensitive surface pointing devices have advantages and drawbacks. The following invention offers ways of combining mechanical pointing devices and touch sensitive surfaces to form a single unified pointing device take the advantages from both types.

### SUMMARY OF THE INVENTION

There is thus provided, in accordance with some preferred embodiments of the present invention, a user interface pointing apparatus for an electronic device, the apparatus comprising:

a primary mechanical knob operated by a user using movement operations; one or more secondary touch sensitive surfaces operated by the user using touching operations, the primary mechanical knob being adjacent to the one or more touch sensitive surfaces;
a processor for receiving the movement operations and the touching operations performed on the mechanical knob and the one or more touch sensitive surfaces, wherein both the movement operations and the touching operations interpreted by the processor as pointing commands to the same pointer.

Furthermore, in accordance with some preferred embodiments of the present invention, the coordinates of the pointer controlled by the pointing apparatus has one or more dimensions.

Furthermore, in accordance with some preferred embodiments of the present invention, the pointing apparatus is used for controlling variety of parameters of objects displayed on the display of the electronic device or parameters of physical objects or physical variables in the electronic device.

Furthermore, in accordance with some preferred embodiments of the present invention, the primary mechanical knob is a track ball or a mouse or a joystick or a wheel or a knob.

Furthermore, in accordance with some preferred embodiments of the present invention, the location of touching on the one or more touch sensitive surfaces is translated to pointer velocity or to pointer location.

Furthermore, in accordance with some preferred embodiments of the present invention, the relative movements over the one or more touch sensitive surfaces are translated to pointer movements.

Furthermore, in accordance with some preferred embodiments of the present invention, faces of the primary mechanical knob are portions of the one or more touch sensitive surfaces.

Furthermore, in accordance with some preferred embodiments of the present invention, the one or more touch sensitive surfaces are at least partially covers the primary mechanical knob.

Furthermore, in accordance with some preferred embodiments of the present invention, the one or more touch sensitive surfaces are located peripherally to the primary mechanical knob.

Furthermore, in accordance with some preferred embodiments of the present invention, some of the one or more touch sensitive surfaces are located adjacent a portion of periphery of the primary mechanical knobs.

Furthermore, in accordance with some preferred embodiments of the present invention, the pointing commands produced by the processor during the touching part of a single stroke, comprises movement operations followed by touching operations, is interpreted by the processor using features from the movement operations of the stroke.

Furthermore, in accordance with some preferred embodiments of the present invention, the pointing commands produced by the processor during the movement part of a single stroke, comprises touching operations followed by movement operations, is interpreted by the processor using features from the touching operations of the stroke.

There is thus provided, in accordance with some preferred embodiments of the present invention, a method for inputting information into an electronic device using a pointing user interface apparatus, the method comprising:

providing a user interface pointing apparatus comprising:
primary mechanical knob operated by a user using movement operations;
one or more secondary touch sensitive surfaces operated by the user using touching operations, primary mechanical knob being adjacent to the one or more touch sensitive surfaces;
processor for receiving the movement operations and the touching operations performed on the mechanical knob and the one or more touch sensitive surfaces, inputting both by the movement operations and by the touching operations are interpreted as pointing commands to a single pointer.

Furthermore, in accordance with some preferred embodiments of the present invention, the coordinates of the pointer controlled by the method has one or more dimensions.

Furthermore, in accordance with some preferred embodiments of the present invention, the method is used for controlling variety of parameters of objects displayed on the display of the electronic device or parameters of physical objects or physical variables in the electronic device.

Furthermore, in accordance with some preferred embodiments of the present invention, the location of touching on the one or more touch sensitive surfaces is translated to pointer velocity or to pointer location.

Furthermore, in accordance with some preferred embodiments of the present invention, the relative movements over the one or more touch sensitive surfaces are translated to pointer movements.

Furthermore, in accordance with some preferred embodiments of the present invention, the pointing commands produced by the processor during the touching part of a single stroke, comprises movement operations followed by touching operations, is interpreted using features from the movement operations of the stroke.

Furthermore, in accordance with some preferred embodiments of the present invention, the pointing commands produced by the processor during the movement part of a single stroke, comprises touching operations followed by movement operations, is interpreted using features from the touching operations of the stroke.

### BRIEF DESCRIPTION OF THE DRAWINGS

Some embodiments of the invention are herein described, with reference to the accompanying drawing, wherein:

FIG. 1 is an isometric view of a track ball based pointing device contains the preferred embodiment of the invention.

FIG. 2 is an isometric view of a mouse based pointing device contains the preferred embodiment of the invention.

FIG. 3 is an isometric view of a joystick based pointing device contains the preferred embodiment of the invention.

FIG. 4 is an isometric view of a 1-D knob based pointing device contains an embodiment of the invention.

FIG. 5 is an isometric view of a 1-D scroll wheel based pointing device contains an embodiment of the invention. The 1-D scroll wheel based pointing device is integrated in to a mouse.

### DESCRIPTION OF SPECIFIC EMBODIMENTS OF THE INVENTION

The present invention is a user interface pointing apparatus for electronic device, comprising an arrangement of at least one mechanical knob and one or more touch sensitive surfaces. By “mechanical knob” is meant, for the purpose of the present invention a button or a handle or a wheel or a joystick or a mouse or a trackball or a knob or a similar apparatus that comprises a mechanical mechanism that is operated by pressing, pushing, sliding, rolling, rotating, or by any other physical movement, referred to hereafter as “movement operations”. Touching or moving a finger or any other object over the touch sensitive surface is referred hereafter as “touching operations”. Both “movement operations” and “touching operations” are referred to hereafter as “input operations”

The input operations of the user interface apparatus, according to the present invention, may be performed by a finger, by hand, by a stylus or by any other similar objects or organs.

The mechanical knobs and the touch sensitive surface are provided adjacently, so that there is either physical contact between them or that they are in close proximity with each other. Overlapping between the mechanical knob and the touch sensitive surface is also covered by the term “adjacently”.

This arrangement allows a user to enter “input operations” in continuous activation. The order of activation may vary, so that the continuous activation may comprise touching operations followed by movement operations, or movement operations followed by touching operations or even simultaneous—or substantially simultaneous—touching operations and movement operations. This may be in the form of a movement across at least a portion of a touch sensitive surface over to one or more mechanical knobs, movement over a mechanical knob over to the touch sensitive surface, or simultaneous contact with the touch sensitive surface and at least one mechanical knob. A continuous movement may be in one or more directions. “Single stroke” in the context of the present invention comprises a single continuous sequence of input operations. The stroke starts when the finger starts touching any touch sensitive surface or starts moving the mechanical knob. The stroke ends when the finger detaches from the touch sensitive surface or ends moving the mechanical knob.

The pointing apparatus processes the input operations and sends pointing commands to move a pointer on the device. By “pointer” is meant, for the purpose of the present invention a pointer or a cursor or a marker or any symbol presented on the device's display. The term “pointing commands” is referred to the interface between the pointing apparatus processor and the device processor. The pointing commands control the changes of the pointer position over time.

Pointing devices are used to control a variety of device parameters, hence the terms “pointing apparatus” as well as “pointer” and “pointer commands” are referred hereafter also to controlling any kind of countable or continues parameter in the device. This may be a parameter of an object displayed by the system, such as location, scale or rotation of an object on the display, scrolling a list or a pane view on the display. It may also represent a physical variable in the device or system such as voltage, resistance, capacitance, opening aperture of a valve or location or orientation of real objects in the system. The pointer state of value may be two-dimensional (2-D) in nature as in the case of a position of a pointer on a display but may also be one-dimensional (1-D) such as a pointer on a time axis. Additionally or alternatively, a three dimensional (3-D) pointer is used, for example, to place a pointer on a 3-D model or even six-dimensional (6-D) pointer to place an object with its orientation on space.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

### EXAMPLES

Reference is now made to the following examples, which together with the above descriptions illustrate some embodiments of the invention in a non limiting fashion.

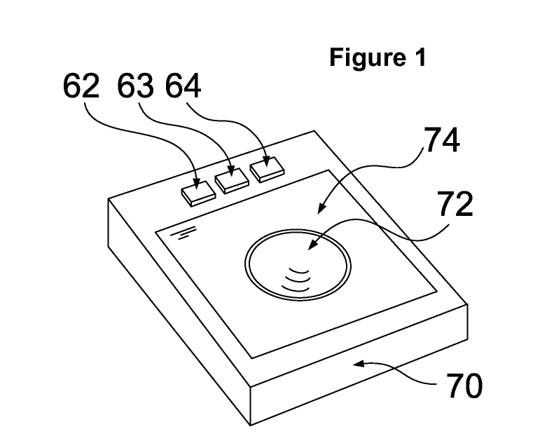

A preferred embodiment according to the present invention is implemented in a track ball style pointing device illustrated in FIG. 1. FIG. 1 describes a pointing device 70 comprising both a track ball 72 and a touch sensitive surface 74 surrounding track ball 72. Optionally, pointing device 70 includes left, middle and right click buttons, 62, 63 & 64 respectively.

The user can perform “movement operations” by rolling the track ball in two dimensions to change the cursor 2-D position on the system display. Track balls are common pointing devices and are well known in their comfort and accuracy where small movements are required and hence they are very popular in CAD engineering systems. Track balls are less convenient where large movement is needed and many rotations of the ball are required.

The present invention adds a touch sensitive surface 74 surrounding track ball 72. This surface functionality complements the track ball and is used when a less accurate but larger movement is required. The user performs “touching operations” by touching with its finger any area of touch sensitive surface 74. The center of track ball 72 is considered as the (0,0) point in the (x,y) coordinate system of touch sensitive surface 74. Any touch at point (x,y) over touch sensitive surface 74 is interpreted by the processor as a cursor movement command with a velocity relative to the length of the vector (x,y) and the direction of the cursor movement is in accordance with the angle of the vector (x,y). In this arrangement, very small velocities cannot be selected by the touchpad since they are related to area where the track ball is located. Indeed, slow cursor movements are exactly the type of operations the user would prefer to perform in device 70 with track ball 72.

Moving the cursor from one side of the screen to the other side, may involve many rotations of track ball 72. As an alternative, in the current invention, the user can continue the movements of the cursor started with a roll of track ball 72, by letting his finger reach the touch sensitive surface 74. Holding the finger in that position will continue the movement of the cursor. To increase the speed of cursor movement the user may slide his finger outwards. Movement of the finger back towards the center reduces the cursor speed. By changing the angular position of the finger on touch sensitive surface 74 the users can change the direction of the mouse movement as well. When the cursor reaches an area where high resolution and small movement of the cursor is desired, the user simply disengages touch sensitive surface 74 and starts rolling track ball 72.

Optionally, touch sensitive surface 74 sensor may be a simple and cheap area touch sensor. In this case, touching anywhere on surface 74 generates a simple touch event to the processor without coordination information. The processor interprets this input operation as moving the cursor in the same velocity and direction that was defined by track ball 72 previously.

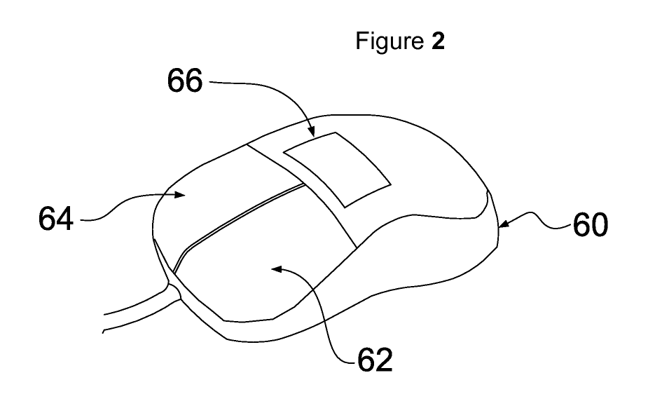

Reference is made now to FIG. 2. In this figure, a mouse like pointing device 60 according to a preferred embodiment of the present invention is presented. In addition to the standard right and left click buttons 62, 64, device 60 has a touch sensitive surface 66. Moving mouse 60 over the pad or desk are the “movement operations”. Touching or moving the finger over touch sensitive surface 66 are the “touching operations”. Both input operations are used for pointing.

Although a mouse is known to be quite flexible pointing device, large movements of the cursor requires repositioning of the mouse into the mouse pad area, and very accurate pointing is also sometime hard to achieve. To overcome this, in some systems the mouse speed rate (the ratio between the distance of movement of the mouse to the pixel movement of the cursor) may be configured between low speed rates to enable high accuracy and high speed rates to allow fast movement of the cursor. In some systems a smart algorithm is used to increase the mouse speed when mouse velocity is greater then some threshold. Using the present invention such sophisticating and confusing solution is unnecessary. Mouse speed rate may be set to low for high accuracy while the touch surface speed rate is set to high to provide fast movement. Alternatively, mouse speed rate is set to high for fast movement and the touch surface is set to low to provide high accuracy.

Device 60 may be operated in three styles: (a) mouse style where the palm covers the mouse and only movement operations are performed; (b) touchpad style where a finger is touching the touch surface and the mouse is fixed; (c) simultaneous mode where the thumb and middle finger move the mouse while the index finger touches the surface. To allow the usage of mouse style, the processor senses the condition where the entire touch sensitive surface is covered by the palm and disables touch sensing reading in this case.

Touch sensitive surface 66 touching operations may be processed in three styles as well: (a) velocity mode where the point of touching is interpreted as the velocity and direction, as described in details in the previous track ball device; (b) absolute location mode where the position on the surface indicates the position on the screen; and (c) relative mode where the relative movement on the touch surface is converted to relative movement of the cursor. In general, modes (a) and (b) are more appropriate for fast movement while mode (c), with proper speed rate conversion, is more appropriate for accuracy.

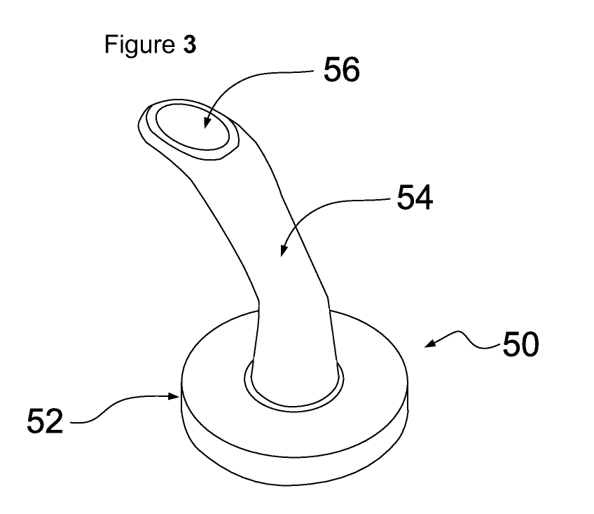

Reference is made now to FIG. 3. In this figure, a joystick-like pointing device is presented. Device 50 comprises a base 52, a moveable stick 54 and a touch sensitive surface 56. The “movement operations” are done by moving stick 54 while the touching operations are done by touching touch sensitive surface 56. Touching operations are most likely performed by the thumb while the other fingers grip stick 54. As in the embodiment describe in FIG. 2 depending on the speed rate setting of stick 54, touch sensitive surface 56 may be used for slow and accurate cursor movements or fast and inaccurate cursor movements. Optionally, a quick tap on touch sensitive surface 56 may be interpreted by the processor as a button click or joystick ‘fire’ command.

Optionally, disengaging stick 54 form base 52 while having a wireless positioning system that measures the position of stick 54 relative to base 52, implements a 3-dimensional or even up to 6-dimensional pointing device.

Previously described embodiments demonstrate mainly the most popular 2-D pointing devices while the last paragraph describes 3-D and 6-D pointing device as well. The next preferred embodiments describe last but not least important 1-D pointing devices in accordance with the present invention.

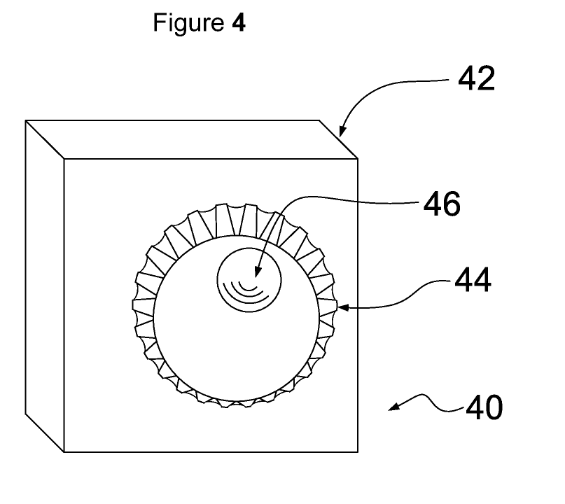

Reference is made now to FIG. 4. In this figure, a knob 44 is attached to a panel 42 of an electronic device 40. Such a 1-D control user interface is very popular for example in test equipment, medical equipment and industrial control systems. The pointing commands in this case may be moving a cursor or marker on a display but may be also, for example, scrolling operations on the display, selection of an item from lists or setup of a countable or continuous value of a parameter such as time scale, voltage, resistance, capacitance, opening aperture of a valve or displacement between objects in the system.

The user changes the position of the marker on the display by turning knob 44 leftwards or rightwards. To allow comfortable multi-turn movement operations, dimple 46 is located on knob 44. In the present invention, dimple 46 is also a touch sensitive surface. When user rolls knob 44 and afterward stops rolling but continue to touch dimple 46, the processor interprets this action as if the user would like to continue with the rolling of knob 44 in the same direction and rate of knob 44 just before knob 44 had been halted. This type of operation is simple and comfortable replacement for tedious multi-turn operation.

Additionally or alternatively, the entire knob 44 top surface is a touch sensitive surface and the user can circle over the touch surface with his finger to generate the pointing commands by the touching operations rather then with the moving operations, i.e., by rolling knob 44. The direction of the circling determines the direction of the marker movement and the velocity of circling determines the speed of marker movement. Each type of operation may have its own different speed conversion rate, so, for example, one cycle of knob movement operation may be 20 pixel movement of the marker, while one cycle of touch surface touching operation may be 200 pixels. Optionally, the touch sensitive surface may have the lower conversion rate while the mechanical knob has the higher conversion rate.

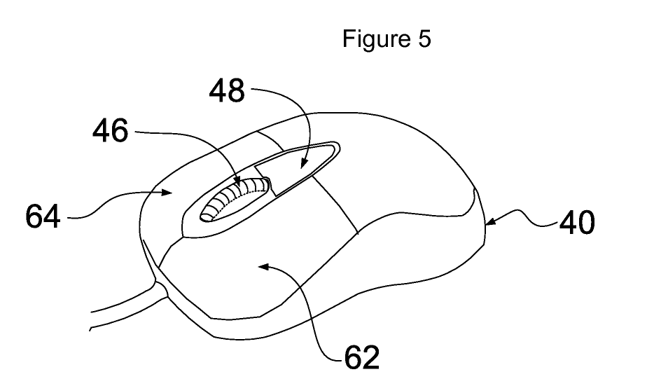

Reference is made now to FIG. 5. FIG. 5 presents a mouse pointing device 40 with standard left and right click buttons, 62 & 64 respectively. Mouse 40 integrates a scroll wheel 46. The scroll wheel is a one dimensional mechanical pointing device. In accordance with the present innovation a new novel touch sensitive surface 48 located to the side of scroll wheel 46. Scroll wheel 46 is generally used to scroll the computer screen up or down depending on the rolling direction of the wheel. However, extended scroll operations may be tedious and need many successive rolling operations that keep the finger performing sequences of touch, roll, detach repeatedly. Instead, in the current invention, when the user long for continuous scroll he just start rolling scroll wheel 46 and when the finger reaches scroll wheel 46 junction with touch sensitive surface 48, the finger continues to touch surface 48. This operation will cause a continuous scrolling as long as the user touches surface 48. Moreover, the user can slide the finger over the surface away from scrolling wheel 46 to increase the scrolling speed and back to the direction of scrolling wheel 46 to decrease the scrolling speed.

While the embodiments described herein with reference to the accompanying figures deal with a combination of a single mechanical knob and a single touch sensitive surface it is maintained that providing a combination plurality of mechanical knobs with plurality of touch sensitive surface is a straight forward extension of the embodiments described and is definitely covered by the scope of the present invention.

While the embodiments described herein with reference to the accompanying figures deal mainly with interpreting the input operations to pointer, cursor or marker movement operations, it is maintained that using the pointing device to scrolling, scaling, rotating an objects or controlling any countable or continues parameters of a system is a straight forward extension of the embodiments described and is definitely covered by the scope of the present invention.

It will be appreciated by persons skilled in the art that the present invention is not limited to what has been particularly shown and described hereinabove rather, the scope of the present invention includes many combination and sub-combination of various mechanical knobs shapes and designs and many touch sensitive surface technologies, shapes, designs, method of operation and various methods to interpret these user activities to device functions and pointing operations. The present invention includes as well variation and modification thereof that are not in prior art, which would occur to persons skilled in the art upon reading the foregoing description.

What is claimed is:

1. A user interface pointing apparatus for an electronic device, the apparatus comprising:
a primary mechanical knob operated by a user using movement operations;
one or more secondary touch sensitive surfaces operated by the user using touching operations, said primary mechanical knob being adjacent to said one or more touch sensitive surfaces;
a processor for receiving said movement operations and said touching operations performed on said mechanical knob and said one or more touch sensitive surfaces, wherein both said movement operations and said touching operations interpreted by the processor as pointing commands to the same pointer.

2. The apparatus of claim 1, wherein the coordinates of said pointer controlled by said pointing apparatus has one or more dimensions.

3. The apparatus of claim 1, wherein said pointing apparatus is used for controlling variety of parameters of objects displayed on the display of said electronic device or parameters of physical objects or physical variables in said electronic device.

4. The apparatus of claim 1, wherein said primary mechanical knob is a track ball or a mouse or a joystick or a wheel or a knob.

5. The apparatus of claim 1, wherein the location of touching on said one or more touch sensitive surfaces is translated to pointer velocity or to pointer location.

6. The apparatus of claim 1, wherein the relative movements over said one or more touch sensitive surfaces are translated to pointer movements.

7. The apparatus of claim 1, wherein faces of said primary mechanical knob are portions of said one or more touch sensitive surfaces.

8. The apparatus of claim 1, wherein said one or more touch sensitive surfaces are at least partially covers said primary mechanical knob.

9. The apparatus of claim 1, wherein said one or more touch sensitive surfaces are located peripherally to said primary mechanical knob.

10. The apparatus of claim 1, wherein some of said one or more touch sensitive surfaces are located adjacent a portion of periphery of said primary mechanical knobs.

11. The apparatus of claim 1, wherein said pointing commands produced by said processor during the touching part of a single stroke, comprises movement operations followed by touching operations, is interpreted by said processor using features from the movement operations of the stroke.

12. The apparatus of claim 1, wherein said pointing commands produced by said processor during the movement part of a single stroke, comprises touching operations followed by movement operations, is interpreted by said processor using features from the touching operations of the stroke.

13. A method for inputting information into an electronic device using a pointing user interface apparatus, the method comprising:
providing a user interface pointing apparatus comprising:
primary mechanical knob operated by a user using movement operations;
one or more secondary touch sensitive surfaces operated by the user using touching operations, primary mechanical knob being adjacent to said one or more touch sensitive surfaces;
processor for receiving said movement operations and said touching operations performed on said mechanical knob and said one or more touch sensitive surfaces,
inputting both by said movement operations and by said touching operations are interpreted as pointing commands to a single pointer.

14. The method of claim 13, wherein the coordinates of said pointer controlled by said method has one or more dimensions.

15. The method of claim 13, wherein said method is used for controlling variety of parameters of objects displayed on the display of said electronic device or parameters of physical objects or physical variables in said electronic device.

16. The method of claim 13, wherein the location of touching on said one or more touch sensitive surfaces is translated to pointer velocity or to pointer location.

17. The method of claim 13, wherein the relative movements over said one or more touch sensitive surfaces are translated to pointer movements.

18. The method of claim 13, wherein said pointing commands produced by said processor during the touching part of a single stroke, comprises movement operations followed by touching operations, is interpreted using features from the movement operations of the stroke.

19. The method of claim 13, wherein said pointing commands produced by said processor during the movement part of a single stroke, comprises touching operations followed by movement operations, is interpreted by using features from the touching operations of the stroke.
